(19) United States
(12) Patent Application Publication
(10) Pub. No.: US 2020/0094516 A1
(43) Pub. Date: Mar. 26, 2020

(54) REINFORCED SANDWICH PANELS

(71) Applicants: Dow Global Technologies LLC, idland, MI (US); Dow Italia Divisione Commerciale SRL, Milan (IT)

(72) Inventors: Andreas Ottens, Everswinkel (DE); Francesca Pignagnoli, Reggio Emilia (IT); Luigi Bertucelli, Reggio Emilia (IT)

(21) Appl. No.: 16/472,151

(22) PCT Filed: Dec. 11, 2017
(86) PCT No.: PCT/US2017/065550

§ 371 Date: Jun. 20, 2019

(30) Foreign Application Priority Data
Dec. 20, 2016 (IT) 102016000128519

(51) Int. Cl. B32B 5/18; B32B 27/40

(52) U.S. Cl. CPC B32B 5/18; B32B 15/046; B32B 27/40

(57) ABSTRACT

The present disclosure provides a panel, comprising a first outer skin consisting of a metal facing, at least two thermal insulation layers, with at least one of which consisting of a rigid polyurethane or polyisocyanurate foam, and at least one reinforcement layer spaced apart from the two outer skins and between two thermal insulation layers. It further provides a process for preparing the panel.

### REFERENCE TO RELATED APPLICATIONS

The present application claims the benefit of Italy Application No. 102016000128519, filed on Dec. 20, 2016.

### FIELD

This disclosure relates to reinforced sandwich panels and panel arrangements including at least one reinforcement layer, to constructions including such panels, and to methods of forming the panels and panel arrangements.

### INTRODUCTION

Rigid polymer foams provide good thermal insulation and are thus used in building components such as “sandwich” pre-insulated panels. The panels may be structural or self-supporting and used in, e.g., internal partition walls, external walls, facades, and roofs.

### SUMMARY

The present disclosure provides a panel, comprising a first outer skin consisting of a metal facing, at least two thermal insulation layers, with at least one of which consisting of a rigid polyurethane or polyisocyanurate foam, and at least one reinforcement layer spaced apart from the two outer skins and between two thermal insulation layers.

It further provides a process for preparing the panel.

### DETAILED DESCRIPTION

Sandwich panels of the present disclosure include a rigid polyurethane/polyisocyanurate (PUR/PIR) foam layer bonded to a metal facing, e.g., of steel, aluminum, or stressed skins of metal foil. Embodiments relate to a sandwich panel that includes two outer skins, with at least one of said outer skins consisting of a metal facing, at least two thermal insulation layers, with at least one of said thermal insulation layers consisting of a rigid polyurethane/polyisocyanurate (PUR/PIR) foam, and at least one reinforcement layer spaced apart from the two outer skins and between two thermal insulation layers.

Outer Skin

A first outer skin consisting of a metal facing is arranged near one rigid polyurethane/polyisocyanurate (PUR/PIR) foam layer so that at least one rigid polyurethane/polyisocyanurate (PUR/PIR) foam layer is between the first outer skin of metal facing and a reinforcement layer. A second outer skin may be included in the panel on the opposite face from the first outer skin of metal facing. The first and second outer skins may be the same or different. The first outer skin of metal facing is made of steel (e.g., lacquered, pre-painted, or galvanized steel) or aluminum, and has a thickness of from 0.2 mm to 2 mm (e.g., 0.3 to 0.8 mm, 0.4 to 0.6 mm, etc.).

According to an exemplary embodiment, the second outer skin may be made of a same material and have a same thickness as the first outer skin.

According to another exemplary embodiment, the second outer skin may be made of other rigid materials such as calcium sulfate dihydrate (gypsum) with or without additives pressed between a facer and a backer (the formed layer is known as a drywall, a plasterboard, a wallboard, a gypsum panel, or gypsum board), and cement.

Thermal Insulation Layers

The panel includes a first thermal insulation layer comprising a rigid polyurethane foam and/or rigid polyisocyanurate foam (PUR/PIR foam). The layer may have a thickness of from 20 mm to 250 mm. The PUR/PIR foam may be formed from an isocyanate-reactive component (e.g., combined with a blowing agent and a catalyst) and an isocyanate component (e.g. an organic polyisocyanate such as commercial mixtures of methylene diphenyl diisocyanate and oligomers thereof). Exemplary materials for forming the PUR/PIR foam include VORACOR™ polyols, VORATHERM™ polyols, VORATHERM™ additives such as catalysts, and VORANATE™ isocyanates (all available from the Dow Chemical Company). An exemplary blowing agent is n-pentane. The isocyanate-reactive component comprises one or more types of polyols selected from polyester polyols and polyether polyols. Use of polyether or polyester polyols will result in polyurethane polymer backbones characterized by the presence of ether or ester repeat units, respectively. Isocyanurate rings can be incorporated in the polymer structure by reacting a stoichiometric excess (relative to the isocyanate-reactive composition) of isocyanate in the presence of specific catalysts. As the isocyanurate ring structure is characterized by high thermal stability, isocyanurate-modified polyurethanes (commonly known as polyisocyanurate (PIR)) are more suitable for high temperature applications, and show improved fire retardancy and lower smoke production on combustion.

For PUR foam, the isocyanate index may be 180 or less. For PUR foam, the isocyanate index may be 100 or higher. For PIR foam, the isocyanate index may be 180 or higher, preferably may be 250 or higher. For PIR foam, the isocyanate index may be less than 500. The term “isocyanate index” refers to the number of equivalents of isocyanate-containing compound added per 100 theoretical equivalents of isocyanate-reactive compound. An isocyanate index of 100 corresponds to one isocyanate group per isocyanate-reactive hydrogen atom present, such as from water and the polyol composition. A higher index indicates a higher amount of isocyanate-containing reactant.

In order to provide adequate foam strength, the functionality and equivalent weights of reactants are properly selected.

The isocyanate component may include isocyanate-containing reactants that are aliphatic, cycloaliphatic, alicyclic, arylaliphatic, and/or aromatic polyisocyanates and derivatives thereof. Exemplary derivatives include allophanate, biuret, and NCO terminated prepolymer. According to an exemplary embodiment, the isocyanate component includes at least one aromatic isocyanates, e.g., at least one aromatic polyisocyanate. For example, the isocyanate component may include aromatic diisocyanates such as at least one isomer of toluene diisocyanate (TDI), crude TDI, at least one isomer of diphenyl methylene diisocyanate (MDI), crude MDI, and/or higher functional methylene polyphenyl polyisocyanate. As used herein MDI refers to polyisocyanates selected from diphenylmethane diisocyanate isomers, polyphenyl methylene polyisocyanates and derivatives thereof bearing at least two isocyanate groups. Blends of polymeric and monomeric MDI may also be used. The MDI advantageously has an average of from 2 to 3.5 (e.g., from 2.0 to 3.2) isocyanate groups per molecule. Exemplary isocyanate-containing reactants include VORANATE™ M229 PMDI isocyanate (a polymeric methylene diphenyl diisocyanate with an average of 2.7 isocyanate groups per molecule, available from The Dow Chemical Company) and VORANATE™ M600 PMDI (a higher functionality polymeric methylene diphenyl diisocyanate oligomeric mixture, available from The Dow Chemical Company).

For the preparation of PUR foam, the isocyanate-reactive component may contain 30 or more parts (per hundreds parts by weight of the sum of all the compounds containing an active hydrogen) of high functionality polyether polyols. Suitable high functional polyether polyols may have a functionality of 4 or more and an equivalent weight of 180 or less. Equivalent weight (EW) is defined as the weight of the compound per reactive site. The equivalent weight may be calculated as EW=56.1×1000/OH where OH=hydroxyl number. Suitable high functional polyether polyols include alkoxylation products of sorbitol, sucrose or aliphatic and aromatic amines. Suitable polyether polyols includes VORANOL™ 482, VORANOL™ 490, VORANOL™ RH360, and VORANOL™ RA640, TERCAROL™ 5902, available from The Dow Chemical Company. The high functionality polyether polyols described above may be used in combination with other polyols having lower functionality and/or higher EW. Suitable polyether polyols of this type include VORANOL™ CP260, VORANOL™ CP450, VORANOL™ CP1055 and VORANOL™ P1010, available from The Dow Chemical Company.

For the preparation of PIR foams, the isocyanate-reactive component may contain 40 or more parts (per hundred parts of the sum of all the compounds having an active hydrogen) of polyester polyols. Suitable polyester polyols include reaction products of aromatic dicarboxylic acid or their derivatives, such as terephtalic acid or phtalic anhydride, with polyhydric alcohols, such as diethylene glycol, polyethylene glycol or glycerine. Exemplary polyester polyols may include STEPANPOL™ PS-3152, STEPANPOL™ PS-2352, available from Stepan Company, and TERATE™ HT2000 available from Invista Company. The relatively low functionality of these polyols is compensated by the polymer crosslinking which is achieved by the isocyanurate ring structure. Suitable polyester polyols may have a functionality of 1.8 or higher. They may have a functionality of 3 or lower. Suitable polyester polyols may have an EW of 160 or higher, e.g. 180 to 280. Suitable polyol mixtures for high index polyisocyanurate formulation may also contain longer chain polyols having an equivalent weight of more than 300. Long chain polyols may help control crosslinking density and reduce brittleness. Such polyols are also believed to promote bonding to metal facings (e.g., steel facings). The long chain polyol of the polyol component may be a polyether polyol and/or a polyester polyol. The functionality of the long chain polyol may be from 2 to 3.

At least one catalyst may be used in forming the polymer foam, e.g., catalyst known in the art may be used. Exemplary catalysts include urethane and trimerisation catalysts, the former for promoting reaction of isocyanate with polyols, the latter of isocyanate with itself. Examples of urethane catalyst include dimethylcyclohexylamine and triethylenediamine. Examples of trimerization catalyst include tris(dialkylaminoalkyl)-s-hexahydrotriazines (such as 1,3,5-tris(N,N-dimethylaminopropyl)-s-hexahydrotriazine); Dabco® TMR 30, Dabco® K-2097 (potassium acetate), Dabco® K15 (potassium 2-ethylhexanoate), and Dabco® TMR, Polycat® 41, Polycat® 43, Polycat® 46, and Curithane® 52, available from Air Products Company; tetraalkylammonium hydroxides (such as tetramethylammonium hydroxide), alkali metal hydroxides (such as sodium hydroxide), alkali metal alkoxides (such as sodium methoxide and potassium isopropoxide), and alkali metal salts of long-chain fatty acids having 10 to 20 carbon atoms. Some catalysts are solid or crystals, and can be dissolved in proper solvents like polyol, dipropylene glycol, or any other solvents compatible with the PUR/PIR foam. Examples of such catalysts compositions include Dabco® 33 LV (triethylediamine dissolved in dipropylene glycol) available from Air Products Company and VORATHERM™ CN626 catalyst available from The Dow Chemical Company.

A chain extender, a cross-linking compound, additives such as surfactants and flame retardants and blowing agents may be used in forming the polymer foam. Suitable flame retardants includes halogenated and phosphorous-based compounds. Exemplary flame retardants includes tris-chloroisopropylphosphate (TCPP) and triethylphosphate (TEP). Suitable physical blowing agents are low-boiling liquids. Several physical blowing agents may be employed such as hydrofluorocarbon (HFC), hydrocarbons and hydrofluoroolefines (HFO). Blowing agent can also be generated as a result of chemical reactions. The most common chemical blowing agent is water. The reaction of water with isocyanate proceeds via the formation of carbamic acid, an unstable intermediate with dissociate liberating CO₂.

Commercially available mixtures of polyols, surfactants and additives for preparing the PIR foam include VORATHERM™ CN 804 polyol and VORATHERM™ CN 815 polyol, available from The Dow Chemical Company.

The panel furthermore includes a second thermal insulation layer. The first and second thermal insulation layers may the same or different. The second thermal insulation layer may be selected among PUR foam, PIR foam, mineral wool (MiWo), and glass wool (GW). The second thermal insulation layer may have a thickness of from 20 mm to 250 mm.

Reinforcement Layer

The panel further includes at least one reinforcement layer between and separating two thermal insulation layers.

Preferably the reinforcement layer is of metal and corresponds substantially to the surface dimensions of the thermal insulation layer in which it is bonded.

Other suitable materials for the reinforcement layer may be in the form of rigid sheets such as plasterboard or fiber-reinforced cement boards. Metal has the advantage of being easier to handle. It can be de-coiled and roll-formed in a continuous process. Moreover, it offers improved strength for relatively low cost.

Panel Structure

In one embodiment, the panel structure includes an outer skin consisting of a metal facing, a first thermal insulation layer consisting of a rigid PUR/PIR foam, a reinforcement layer, a second insulation material layer, and another outer skin arranged in an order from bottom to top.

Manufacturing Process

An exemplary method of forming the panel as described herein may include providing the first outer skin consisting of a metal facing, the first thermal insulation layer in the form of a liquid reaction mixture, the reinforcement layer, and the second thermal insulation layer in the form of a liquid reaction mixture; and applying a second outer skin to the last thermal insulation layer. For example, the sandwich panels may be manufactured by a continuous process or a discontinuous process (e.g., a continuous process or a discontinuous process known in the art). A continuous lamination process may use double belt arrangements, for example, in which a liquid reaction mixture for forming the polymer foam is deposited (poured or sprayed) onto a lower outer skin. The reinforcement layer may be contacted on its downward face with the liquid reaction mixture of forming the polymer foam before it becomes cured and rigid. The discontinuous process may use molds.

A continuous lamination process may include the following: (i) feeding a lower (first) metal facing sheet, (ii) dispensing a first liquid reaction mixture of forming a polymer foam for forming the first thermal insulation layer on top of the lower metal facing sheet, (iii) feeding a reinforcement sheet, (iv) dispensing a second liquid reaction mixture of forming a polymer foam for forming the second thermal insulation layer on top of the reinforcement sheet, (v) conveying an upper (second) metal facing sheet, (vi) allowing the liquid reaction mixtures to expand, cure, and bond to the metal facings and the reinforcement layers (e.g., under continuous pressure using a double conveyor). Separate panels may then be formed by cutting.

According to another embodiment, a continuous lamination process may include the following: (i) feeding rigid sheets (such as plasterboard or cement boards) as the lower layer, (ii) dispensing a first liquid reaction mixture of forming a polymer foam for forming the first thermal insulation layer on top of the lower rigid sheet, (iii) feeding a reinforcement metal sheet, (iv) dispensing a second liquid reaction mixture of forming a polymer foam for forming the second thermal insulation layer on top of the reinforcement sheet, (v) conveying an upper metal facing sheet, (vi) allowing the liquid reaction mixtures to expand, cure, and bond to the outer skins and the reinforcement layers (e.g., under continuous pressure using a double conveyor).

The continuous production line may utilize a single forming station with the provision that suitable devices are in place (e.g. by means of engagement along the forming longitudinal edges of the panel) to hold in position the reinforcement layer until the liquid reaction mixtures of forming the polymer foams are cured. Alternatively, the continuous production line may utilize two forming stations using a first and a second double conveyor, one after the other, wherein the opposed belts of the first and the second double conveyors are spaced-apart for the thickness to allow, first, the forming of the first insulation layer, and then the overall panel. Arrangements with multiple forming stations are disclosed, as an example, in U.S. Pat. No. 8,617,699.

Arrangements to assist in even distribution of the liquid reaction mixtures across the width of the prospective panel may help for panel quality. For example, a discharging hose having an end travelling across a specific width (e.g., by means of a swing bar) or a pipe extending across the width of the line and provided with a number of discharging holes may be used.

A discontinuous process using molds may include positioning the first outer skin and the reinforcement layer in a mold (e.g., a heated mold) and injecting the liquid reaction mixture for forming the polymer foam for the first thermal insulation layer (e.g., using a foaming machine) so as to fill the mold cavity and adhere to the first outer skin and the reinforcement layer.

The discontinuous process using a mold may further include positioning the first thermal insulation layer coated with the first outer skin consisting of a metal facing and the reinforcement layer, and a second outer skin in a mold, and injecting the liquid reaction mixture for forming the foam layer for the second thermal insulation layer so as to fill the mold cavity and adhere to the reinforcement layer and the second outer skin.

Other manufacturing process embodiments relate to the production of panels where the first thermal insulation layer consists of the polymer foam formed from a liquid reaction mixture (e.g. PUR or PIR foams) while the second thermal insulation layer (e.g. MiWo or GW) is formed by feeding of slabs. Manufacturing lines may be equipped with a series of machines for loading, cutting, feeding and automatic insertion of slabs of insulation material. The mineral wool slabs may be drawn and cut in layers whose width is equal to the thickness of the insulation layer to be formed. Operations may include rotation, staggering, lateral milling and gluing. The glue may be a bi-component polyurethane and may be distributed on surface by means of two mechanical hands.

### Examples

Sample panels for Working Examples 1 to 5 and Comparative Examples C1 to C3 are prepared using lacquered steel facings and PIR foam layer(s) having a composition according to Table 1, below. In particular, to form a reaction mixture for forming the PIR foam layer, an isocyanate-reactive component is first formed by mixing with a mechanical stirring the VORATHERM™ CN 815 polyol, the VORATHERM™ CN 626 catalyst, and n-pentane. Then after the so-formed isocyanate-reactive component is mixed with a mechanical stirrer with the VORANATE™ M600 PMDI isocyanate.

VORATHERM™ CN 815 polyol is a commercially available formulated polyol component containing polyols and additives. It is characterized by an OH number of 234 mg KOH/g, a water content of 0.8 wt % and a viscosity at 20° C. of 1550 mPa·s. VORATHERM™ CN 626 Catalyst is a commercially available catalyst blend. VORATHERM™ CN 626 Catalyst is characterized by an OH number of 259 mg KOH/g and a viscosity at 20° C. of 160 mPa·s. VORANATE™ M600 PMDI isocyanate is a commercially available isocyanate characterized by a NCO content of 30.3 wt %, an isocyanate functionality of 2.85 and a viscosity at 25° C. of 600 mPa·s.

TABLE 1
PIR foam

| Components | Units | |
|---|---|---|
| VORATHERM ™ CN 815 polyol | Parts by weight | 100 |
| VORATHERM ™ CN 626 catalyst | Parts by weight | 3 |
| n-pentane | Parts by weight | 14 |
| VORANATE ™ M600 PMDI isocyanate | Parts by weight | 195 |
| Isocyanate index | | 275 |

Sample panels for Working Examples 1 to 5 have been prepared in a laboratory mold. They have been characterized for fire-resistance insulation endurance using a muffle furnace.

A horizontal mold of dimensions 200 mm (Length) by 200 mm (Width) by 100 mm (Thickness) heated at 50° C. was used for the preparation of the sample panels. The procedure is as follows:

1) The mold thickness is adjusted (reduced with a spacer) to a first value (e.g. for Working Example 3 it is 50 mm).

2) A release agent is applied to the sides of the mold, a first steel skin (0.4 mm thick, white lacquered) is positioned on the bottom of the mold, and a second steel skin (of same material) is attached to the lid (top) of the mold.

3) A liquid reaction mixture of the first thermal insulation layer, the polyisocyanurate foam, is poured in the mold cavity (amount of reaction mixture calculated for obtaining an applied foam density of 50 kg/m³). The mold is closed. The foam forming reaction mixture fills the cavity and bonds to the inner surfaces of the two steel skins. The polyisocyanurate foam is allowed to cure for a given time.

4) The formed double-skinned steel-faced sandwich panel is demolded.

5) The thickness of the mold is then changed to 100 mm, by removing the spacer.

6) The double-skinned steel faced sandwich panel (for example 50 mm thick) is position in the mold, laid on the bottom. A third steel skin (of same material) is attached to the lid (top) of the mold. The liquid reaction mixture of the second thermal insulation layer, the polyisocyanurate foam, is poured in the new mold cavity (amount of reaction mixture calculated for obtaining an applied foam density of 50 kg/m³). The mold is closed. The foam forming reaction mixture fills the cavity and bonds to the outer surface of the double skinned panel and to the inner surface of the third steel skin. The polyisocyanurate foam is allowed to cure for a given time.

7) The formed panel (overall thickness 100 mm) with three steel sheets and two insulating PIR layers is demolded.

Sample panels for Comparative Examples C1 to C3 have been prepared in a laboratory mold. They have been characterized for fire-resistance insulation endurance using a muffle furnace.

A horizontal mold of dimensions 200 mm (Length) by 200 mm (Width) by 100 mm (Thickness) heated at 50° C. was used for the preparation of the sample panels. The procedure is as follows:

1) The mold thickness is fixed to 100 mm.

2) A release agent is applied to the sides of the mold, a first steel skin (0.4 mm thick, white lacquered) is positioned on the bottom of the mold, and a second steel skin (of same material) is attached to the lid (top) of the mold.

3) A liquid reaction mixture of the first thermal insulation layer, the polyisocyanurate foam, is poured in the mold cavity (amount of reaction mixture calculated for obtaining an applied foam density of 50 kg/m³). The mold is closed. The foam forming reaction mixture fills the cavity and bonds to the inner surfaces of the two steel skins. The polyisocyanurate foam is allowed to cure for a given time.

4) The formed double-skinned steel-faced sandwich panel is demolded.

The fire resistance insulation endurance was evaluated using an electrical muffle furnace modified with a 170×170 mm opening cut in the vertical front door. Panel samples of dimensions 200×200 mm are clamped in front of the opening. The testing procedure involves the following step:

1) The side edges are wrapped with an insulating blanket of ceramic wool. Aluminum adhesive tape is used to help hold insulation blanket in place during the test.

2) The 200×200 mm specimen are clamped against the opening cut in the door of the muffle furnace.

3) A contact thermocouple is placed on the steel skin facing outward.

4) The heating of the muffle furnace is switched on.

5) The temperature of the thermocouple on the outer skin of the specimen as well as the internal furnace temperature are recorded during the test.

The following panel samples have been prepared and tested:

Working Example 1: a double skinned sandwich panel of 100 mm overall thickness having a third steel sheet separating two thermal insulation layers. The thicknesses of the two thermal insulation layers are 10 and 90 mm individually. The fire resistance insulation endurance is carried out with the insulation layer of 10 mm oriented toward the heat source of the muffle furnace.

Working Example 2: a double skinned sandwich panel of 100 mm overall thickness having a third steel sheet separating two thermal insulation layers. The thicknesses of the two thermal insulation layers are 70 and 30 mm individually. The fire resistance insulation endurance is carried out with the insulation layer of 30 mm oriented toward the heat source of the muffle furnace.

Working Example 3: a double skinned sandwich panel of 100 mm overall thickness having a third steel sheet separating two thermal insulation layers. The thicknesses of the two thermal insulation layers are 50 and 50 mm individually. The fire resistance insulation endurance is carried out with one of the two faces of the panel oriented toward the heat source of the muffle furnace.

Working Example 4: a double skinned sandwich panel of 100 mm overall thickness having a third steel sheet separating two thermal insulation layers. The thicknesses of the two thermal insulation layers are 70 and 30 mm individually. The fire resistance insulation endurance is carried out with the insulation layer of 70 mm oriented toward the heat source of the muffle furnace.

Working Example 5: a double skinned sandwich panel of 100 mm overall thickness having a third steel sheet separating two thermal insulation layers. The thicknesses of the two thermal insulation layers are 10 and 90 mm individually. The fire resistance insulation endurance is carried out with the insulation layer of 90 mm oriented toward the heat source of the muffle furnace.

Comparative Example C1: a double skinned sandwich panel of 100 mm overall thickness having a single insulation layers. The panel has a symmetrical structure. The fire resistance insulation endurance is carried out with one of the two faces of the panel oriented toward the heat source of the muffle furnace.

Comparative Example C2: a double skinned sandwich panel of 100 mm overall thickness having a single insulation layers. An additional steel sheet is placed against one of the faces of the panel. The fire resistance insulation endurance is carried out with the side with the additional steel sheet oriented toward the heat source of the muffle furnace.

Comparative Example C3: a double skinned sandwich panel of 100 mm overall thickness having a single insulation layers. An additional steel sheet is glued against one of the faces of the panel. The glue is a polyurethane/polyisocyanurate obtained mixing 100 parts by weight of VORAMER™ MB3174 polyol and 123 parts by weight of VORANATE™ M220 isocyanate. The amount of glue per surface area is 750 g/m² corresponding to a thickness of approximately 1 mm. The fire resistance insulation endurance is carried out with the side having the additional steel sheet oriented toward the heat source of the muffle furnace.

Fire Resistance Insulation Endurance Test (Table 2)

Table 2 shows the time (in minutes) elapsing from the start of heating to certain threshold temperatures (140° C., 160° C. and 180° C.) measured by mean of a thermocouple on the outer steel skin (opposite to the heat source) of the sandwich panel. Heating profiles inside the muffle furnace have been recorded and found consistent among all the experiments. The heating profile inside the muffle furnace is substantially linear and can be described in terms of time to reach certain temperatures as follows: 30 minutes for 200° C., 60 minutes for 400° C., 120 minutes for 800° C.

Sample panels for Working Examples 1 to 5 (characterized by three steel skins and two PIR foam insulation layers) show remarkable improvements of insulation endurance (on average 10 minutes) when compared with sample panels for Comparative Examples C1 to C3 (double skinned PIR panels and one PIR foam insulation layer). Data of Comparative Examples shows that the improvement cannot be obtained by the mere presence of an additional steel sheet (attached or glued) to the skin of conventional panels.

TABLE 2
Time (minutes) to reach certain temperatures treesholds

| Temperature | | | | | | | | |
|---|---|---|---|---|---|---|---|---|
| (° C.) | C 1 | C2 | C3 | Ex1 | Ex2 | Ex3 | Ex4 | Ex5 |
| 140 | 120 | 119 | 121 | 134 | 128 | 132 | 127 | 135 |
| 160 | 125 | 124 | 126 | 141 | 135 | 139 | 133 | 139 |
| 180 | 131 | 129 | 134 | 143 | 145 | 143 | 138 | 144 |

Sample panels for Working Examples 6 and Comparative Examples C4 have been prepared using a reaction mixture for forming the PIR foam layer and steel facings roll-formed at longitudinal edges to create the tongue-groove engagement. Example 6 and Comparative Example C4 have been produced using a continuous line. The PIR foam layer(s) have a composition according to Table 3, below. In particular, for forming the PIR foam layer(s), a first stream of an isocyanate-reactive component VORATHERM™ CN 804 polyol, a second stream of VORATHERM™ CN 626 catalyst, and a third stream of n-pentane are in-line blended and then reacted by mean of high-pressure impingement mixing with a stream of VORANATE™ M600 PMDI isocyanate.

VORATHERM™ CN 804 polyol is a commercially available formulated polyol component containing polyols and additives. It is characterized by an OH number of 181 mg KOH/g, a water content of 0.8 wt % and a viscosity at 20° C. of 800 mPa·s.

TABLE 3
PIR foam

| Components | Units | |
|---|---|---|
| VORATHERM ™ CN 804 Polyol | Parts by weight | 100 |
| VORATHERM ™ CN 626 Catalyst | Parts by weight | 3.5 |
| normal pentane | Parts by weight | 12 |
| VORANATE ™ M600 Isocyanate | Parts by weight | 171 |
| Isocyanate index | | 293 |

Steel-sheets, white lacquered, 0.40 mm thick, with flat faces and having roll-formed longitudinal edges have been used for both Example 6 and Comparative Examples C4. For both of the Example and Comparative Example the metal sheet running on the bottom has gone through a Corona treatment. Furthermore, as customary in the industry, a thin layer (100 g/m²) of a polyurethane/polyisocyanurate glue obtained mixing 100 parts by weights of VORAMER™ MB3171 Polyol and 123 parts by weight of VORANATE™ M220 Isocyanate has been applied before dispensing the polyisocyanurate foam reaction mixture.

Panel sample of Example 6 has been made preparing, as a first step, a 60 mm double skinned panel, followed by a second step where the opposed belts of the double conveyor has been adjusted to an overall panel thickness to 120 mm for including a second insulation layer and a third steel (top outer skin). Panel of Comparative Example C4 has been prepared in a conventional way feeding a bottom and top steel skins and forming in a single step the 120 mm thick foam insulation layer.

Sample Panels of Example 6 and Comparative Example C4 have been characterized both for mechanical strength and full-scale fire resistance testing.

The mechanical strength has been evaluated by a 4-point bending test, substantially according to the European Standard on Sandwich Panels EN 14509 with the exception of a shorter span length (700 mm). Samples with a width dimension of 100 mm and of full panel thickness were cut from the flat area of the panels. The load has been applied in the direction of the thickness. Table 4 shows the measurements. Sample panels of Example 6 show a mean value of shear strength of 0.100 versus 0.065 of Comparative Example C4, a 53% improvement at same overall panel thickness.

TABLE 4

| | | Example 6 | | | | | Comparative Example C4 | | | | |
|---|---|---|---|---|---|---|---|---|---|---|---|
| Specimen | Units | 1 | 2 | 3 | 4 | 5 | 6 | 7 | 8 | 9 | 10 |
| Load at Break | N | 2435 | 2135 | 2250 | 2650 | 2430 | 1594 | 1645 | 1582 | 1453 | 1503 |
| Shear Strength | N/mm² | 0.103 | 0.09 | 0.095 | 0.111 | 0.102 | 0.067 | 0.069 | 0.067 | 0.061 | 0.063 |
| Shear Modulus | N/mm² | 2.09 | 2.23 | 1.67 | 2.09 | 1.53 | 2.08 | 1.8 | 1.53 | 1.67 | 1.81 |
| Bending at | mm | 30.4 | 26.6 | 26.2 | 35 | 31.5 | 9.4 | 11.2 | 9.3 | 9.6 | 9.1 |
| Break | | | | | | | | | | | |

Large scale fire resistance testing of sample panels for Example 6 and Comparative Example C4 have been carried out according to the European Standard of fire resistance tests for non-loadbearing elements EN 1364. Wall test specimens have been prepared joining together 3 panels along their vertical longitudinal edges to close the 3000 mm×3000 mm furnace opening. The panels have been mounted by simply engaging the groove and tongue of the edges (without screw stitching). The panels have been fixed to a supporting construction of steel profiles, on both sides along three of the four specimen edges. The fourth edge was left unstrained (free edge). The gap between the free edge of the test specimen and the wall of the furnace was filled with slabs of mineral wool. Five thermocouples were placed to measure temperature rise at bodies of panels, others five were placed in proximity of longitudinal joints, of the free edges and of other locations of the perimeter of the test specimen. For panels of Example 6, the first insulation failure has happened at minute 28th triggered by the thermocouple placed in proximity of the upper part of a longitudinal joint. Bodies of panels have behaved exceptionally well (average increase of temperature was of only 19° C. after 28 minutes of test). Deflection of the test specimen was small along the full duration of the test. Panels of Comparative Examples C4 has shown a much earlier failure triggered by the thermocouple placed at the longitudinal joint (at minute 7th). Few minutes after (at minute 11th) a hot spot of 193° C. was recorded by one of the thermocouples placed on panel bodies.

Sample Panels of Working Examples 7 to 9 and Comparative Example C5 have been prepared using a PR foam layer(s) composition according to Table 3. In particular, for forming the PR foam layer(s), an isocyanate-reactive component premix consisting of VORATHERM™ CN 804 Polyol, VORATHERM™ CN 626 Catalyst and normal pentane have been prepared and reacted with VORANATE™ M600 PMDI isocyanate by mean of a high-pressure Krauss Maffei machine. The reaction characteristics have been measured according to common procedures and recorded as follows: cream time 5 seconds, gel time 30 seconds, free-rise density 36.2 kg/m³. The Sample panels, having dimensions of 1000 mm (Length) by 1000 mm (Width) have been prepared under a discontinuous press, the ones of Working Examples 7 to 9 in a two-steps process.

The following Sample panels have been prepared and characterized for mechanical strength.

Working Example 7: a steel double skinned sandwich panel of 80 mm overall thickness having a third steel sheet separating two thermal insulation layers of PIR foam. The three steel sheet are all 0.5 mm thick. The thickness of each thermal insulation layers is 40 mm. The PIR foam molded density is 50 kg/m³.

Working Example 8: as Working Example 7 but the third sheet separating the two thermal insulation layers is a fiber reinforced cement board having a thickness of 15 mm. The thickness of the two thermal insulation layers is 25 mm and 40 mm.

Working Example 9: as Working Example 7 but the second insulation material is a fiber reinforced PIR foam, obtained placing in the mold cavity, before dispensing the PIR forming reaction mixture, an expandable glass fiber web having a weight per unit area of 70 g/m² supplied by Schmelzer Industries. The thickness of both thermal insulation layers is 40 mm.

Comparative Example C5: a steel double skinned sandwich panel of 80 mm overall thickness. The two steel sheet are both 0.5 mm thick. The PR foam molded density is 50 kg/m³.

The mechanical strength has been evaluated by a 4-point bending test substantially according to the European Standard on Sandwich Panels EN 14509 with the exception of a shorter span length (700 mm). For testing, specimen of dimensions 800 mm (Length), 100 mm (Width) and of full panel thickness were cut. The load has been applied in the direction of the thickness. Table 5 shows the measurements of specimen taken from two different positions in the panel and tested according to the two orientation (turning up-down).

Sample panels of Working Example 7 showed an 80% improvement in bending strength compared with conventional panel (Comparative example C5) at same overall thickness of 80 mm. Modulus was also remarkably improved. Working Examples 8 and 9 also show remarkably improved bending strength and modulus compared with conventional panels, demonstrating the broad range of applicability of the invention.

TABLE 5

| | Load at Break | | Shear Modulus | |
|---|---|---|---|---|
| | (N) | | (N/mm²) | |
| | Position 1 | Position 2 | Position 1 | Position 2 |
| Comparative Example C5 (upward) | 1620 | 1390 | 4.03 | 4.04 |
| Comparative Example C5 (downward) | 1900 | 1000 | 3.77 | 3.36 |
| Working Example 7 (upward) | 2730 | 2810 | 6.62 | 7.32 |
| Working Example 7 (downward) | 2830 | 2540 | 6.58 | 6.83 |
| Working Example 8 (upward) | 2960 | 2400 | 9.98 | 7.85 |
| Working Example 8 (downward) | 3000 | 2440 | 10.44 | 5.64 |
| Working Example 9 (upward) | 2130 | 2530 | 5.96 | 6.12 |
| Working Example 9 (downward) | 2520 | 2790 | 6.49 | 7.03 |

Sample Panels of Working Example 7, Working Example 9 and Comparative Example C5 have been also characterized for thermal insulation. Table 6 reports the thermal conductivity values of specimen obtained removing the outer skin and reducing the thickness to 25 mm. For Comparative Example C5, the specimen consists of PIR foam core alone (tested according to DIN52616), For Working Examples 7 and 9 the specimen consist of two insulating layer separated by a stiffener. The inventive panels show comparable thermal conductivity values of conventional panels.

TABLE 6

| | Thermal conductivity at 10° C. (W/m · K) |
|---|---|
| Comparative Example C5 | 0.0232 |
| Working Example 7 | 0.0230 |
| Working Example 9 | 0.0234 |

What is claimed is:

1. A panel, comprising:
a first outer skin consisting of a metal facing,
at least two thermal insulation layers, with at least one of which comprising a rigid polyurethane or polyisocyanurate foam, and
at least one reinforcement layer spaced apart from the two outer skins and between two thermal insulation layers.

2. The panel according to claim 1, wherein the reinforcement layer is made of metal.

3. The panel according to claim 1, wherein the reinforcement layer is made of plasterboard.

4. The panel according to claim 1, wherein the reinforcement layer is made of fiber-reinforced cement boards.

5. The panel according to claim 1, further comprising a second outer skin on the opposite face from the first outer skin.

6. The panel according to claim 5, wherein the second outer skin is made of rigid materials.

7. The panel according to claim 5, wherein the second outer skin is a rigid sheet of a plasterboard.

8. The panel according to claim 5, wherein the second outer skin is a rigid sheet of a cement board.

9. A continuous lamination process for forming the panel as claimed in any one of claims 1-8, the process comprising the following stages of:
(i) feeding the first outer skin, which is a lower first metal facing sheet,
(ii) dispensing a first liquid reaction mixture for forming a first thermal insulation layer, of the at least two thermal insulation layers, on top of the lower metal facing sheet, and
(iii) feeding a reinforcement layer.

10. The continuous lamination process according to claim 9, wherein it further comprises steps of:
(iv) dispensing a second liquid reaction mixture for forming a second thermal insulation layer, of the at least two thermal insulation layers, on top of the reinforcement sheet,
(v) conveying an upper second metal facing sheet, and
(vi) allowing the first and second liquid reaction mixtures to expand, cure, and bond to the metal facings and the reinforcement layers.

11. A continuous lamination process for forming the panel as claimed in any one of claims 1-8, the process comprising the following steps of:
(i) feeding the second outer skin made of rigid materials as a lower layer,
(ii) dispensing a first liquid reaction mixture for forming the first thermal insulation layer, of the at least two thermal insulation layers, on top of the lowermost rigid sheet,
(iii) feeding a reinforcement layer,
(iv) dispensing a second liquid reaction mixture for forming the second thermal insulation layer, of the at least two thermal insulation layers, on top of the reinforcement sheet,
(v) conveying the first outer skin consisting of a metal face,
(vi) allowing the first and second liquid reaction mixtures to expand, cure, and bond to the rigid sheet, the metal facing, and a reinforcement layer.

12. A discontinuous process using a mold for forming the panel as claimed in any one of claims 1-8, comprising positioning the first outer skin and the reinforcement layer in a mold and injecting the liquid reaction mixture for forming a first thermal insulation layer, of the at least two thermal insulation layers, so as to fill the mold cavity and adhere to the first outer skin and the reinforcement layer.

13. The discontinuous process using a mold according to claim 12, wherein it further comprises steps of positioning the first thermal insulation layer coated with the first outer skin consisting of a metal facing and the reinforcement layer, and a second outer skin in a mold, and injecting the liquid reaction mixture for forming the foam layer for the second thermal insulation layer so as to fill the mold cavity and adhere to the reinforcement layer and the second outer skin.
